(19) United States
(12) Patent Application Publication
(10) Pub. No.: US 2020/0336967 A1
(43) Pub. Date: Oct. 22, 2020

(54) ENHANCED PORTABLE DEVICE OPERATION

(71) Applicant: Ford Global Technologies, LLC, Dearborn, MI (US)

(72) Inventor: JAYANTHI RAO, West Bloomfield, MI (US)

(73) Assignee: Ford Global Technologies, LLC, Dearborn, MI (US)

(21) Appl. No.: 16/390,335

(22) Filed: Apr. 22, 2019

(51) Int. Cl. H04W 48/04; H04W 4/02; H04W 4/40; H04W 4/80

(52) U.S. Cl. CPC H04W 48/04; H04W 4/80; H04W 4/40; H04W 4/027

(57) ABSTRACT

A portable device includes a processor and a memory, the memory storing instructions executable by the processor to identify the portable device as being in a vehicle, to identify an application on the portable device that transmits a location of the portable device to the vehicle, and to suppress communication by the application.

### BACKGROUND

Portable devices, such as mobile phones and wearable devices, can communicate with vehicles. The portable devices can transmit data and/or messages to the vehicles, and the vehicles can transmit data and/or messages to the portable devices. The transmissions occur over a network. Such networks typically have dedicated bandwidth for transmissions.

### BRIEF DESCRIPTION OF THE DRAWINGS

FIG. 1 is a block diagram of an example system for operating a portable device in a vehicle.

FIG. 2 is a plan view of the portable device outside of a vehicle.

FIG. 3 is a plan view of the portable device inside a vehicle.

FIG. 4 is a block diagram of an example process for operating the portable device in a vehicle.

### DETAILED DESCRIPTION

A portable device includes a processor and a memory, the memory storing instructions executable by the processor to identify the portable device as being in a vehicle, identify an application on the portable device that transmits a location of the portable device to the vehicle and suppress communication by the application.

The instructions can further include instructions to identify the application upon determining that the application instructs the portable device to communicate with the vehicle over a cellular network.

The cellular network can be a C-V2X network.

The instructions can further include instructions to identify a geo-location of the portable device and to identify the portable device as being in the vehicle upon determining that the geo-location of the portable device is within a distance threshold of a geo-location of the vehicle.

The instructions can further include instructions to identify the portable device as being in the vehicle based on data indicating at least one of speed, acceleration, or angular velocity of the portable device.

The instructions can further include instructions to actuate one or more portable device sensors to collect the data.

The instructions can further include instructions to, upon receiving a periodic message from the vehicle, identify the portable device as being in the vehicle.

The periodic message can be a sequence of light pulses emitted from a vehicle cabin light.

The instructions to identify the application can further include instructions to determine that the application includes programming to receive at least one of a collision warning or a traffic signal from the vehicle.

The instructions can further include instructions to, upon determining that the portable device has exited the vehicle, allow communication by the application.

The instructions to identify the application can further include instructions to determine a message rate of an application and to identify the application when the message rate is below a predetermined threshold.

The instructions to identify the application can further include instructions to determine that the application is programmed to transmit a heading of the portable device to the vehicle.

A method includes identifying a portable device as being in a vehicle, identifying an application on the portable device that transmits a location of the portable device to the vehicle, and suppressing communication by the application.

The method can further include identifying the application upon determining that the application instructs the portable device to communicate with the vehicle over a cellular network.

The method can further include identifying a geo-location of the portable device and identifying the portable device as being in the vehicle upon determining that the geo-location of the portable device is within a distance threshold of a geo-location of the vehicle.

The method can further include identifying the portable device as being in the vehicle based on data indicating at least one of speed, acceleration, or angular velocity of the portable device.

The method can further include actuating one or more portable device sensors to collect the data.

The method can further include, upon receiving a periodic message from the vehicle, identifying the portable device as being in the vehicle.

The method can further include determining that the application includes programming to receive at least one of a collision warning or a traffic signal from the vehicle.

The method can further include, upon determining that the portable device has exited the vehicle, allowing communication by the application.

The method can further include determining a message rate of an application and to identify the application when the message rate is below a predetermined threshold.

The method can further include determining that the application is programmed to transmit a heading of the portable device to the vehicle.

A system includes a portable device including an application that transmits a location of the portable device to a vehicle, means for identifying the portable device as being in the vehicle, means for identifying the application, and means for suppressing communication by the application.

The system can further include means for identifying the application upon determining that an application instructs the portable device to communicate with the vehicle over a cellular network.

The system can further include means for identifying an application including instructions to receive at least one of a collision warning or a traffic signal from the vehicle.

The system can further include means for allowing communication by the application upon determining that the portable device has exited the vehicle.

Further disclosed is a computing device programmed to execute any of the above method steps. Yet further disclosed is a vehicle comprising the computing device. Yet further disclosed is a computer program product, comprising a computer readable medium storing instructions executable by a computer processor, to execute any of the above method steps.

Current LTE (Long Term Evolution) standards support vehicle-to-everything (V2X) communication. Portable devices can include V2X capability to communicate with vehicles. For example, a portable device could include a vehicle-to-pedestrian (V2P) application with programming to transmit information (e.g., a location, a heading, etc.) of the portable device to one or more vehicles according to V2X communications. A vehicle computer could include programming to transmit data including warnings (e.g., a collision warning, an approach warning, a traffic signal, etc.) to one or more portable devices including a V2P application via V2x. However, a portable device in a vehicle typically means that a user in possession of the portable devices is not a pedestrian and is not in danger of collisions with vehicles. In this scenario, V2P applications may be unnecessary and/or undesireable. Moreover, unnecessary communication by portable devices needlessly consumes V2X communications bandwidth and may cause congestion in V2X communications.

Advantageously, suppressing communication of V2P applications of portable devices in vehicles frees bandwidth for other V2P and/or V2X communications. Because the available bandwidth for V2X communications may be limited, reducing the number of portable devices that communicate over V2X provides or frees bandwidth for other V2X communications including for portable devices that should communicate over the V2X network, e.g., devices carried by pedestrians. Reducing congestion of the V2X network can thus allow portable devices outside of any vehicle to communicate more readily with one or more vehicles.

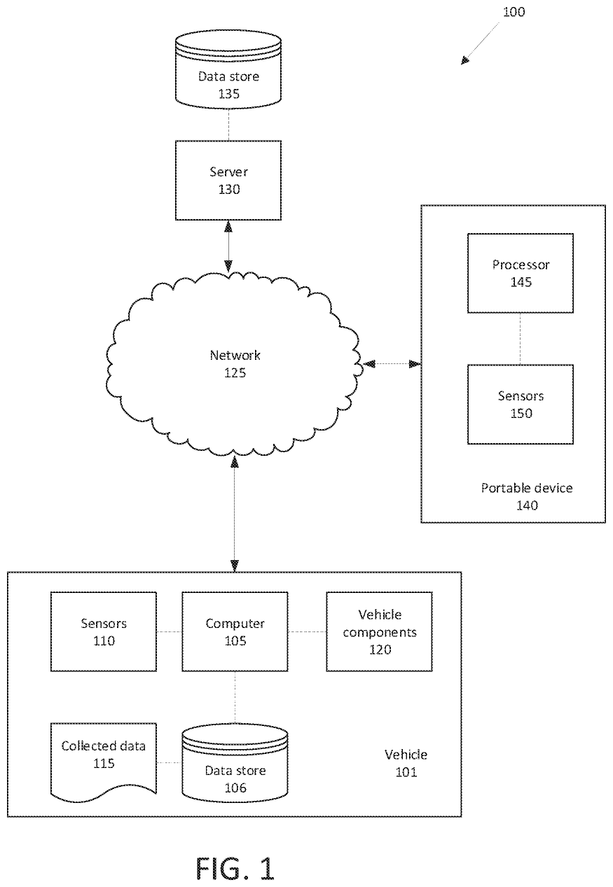

FIG. 1 illustrates a system 100 including a portable device 140 communicatively coupled to a vehicle 101 computer 105. The computer 105 is programmed to receive collected data 115 from one or more sensors 110, e.g., vehicle 101 sensors, concerning various metrics related to the vehicle 101. For example, the metrics may include a velocity of the vehicle 101, vehicle 101 acceleration and/or deceleration, data related to vehicle 101 path or steering, biometric data related to a vehicle 101 operator, e.g., heart rate, respiration, pupil dilation, body temperature, state of consciousness, etc. Further examples of such metrics may include measurements of vehicle systems and components (e.g. a steering system, a powertrain system, a brake system, internal sensing, external sensing, etc.).

The computer 105 is generally programmed for communications on a controller area network (CAN) bus or the like. The computer 105 may also have a connection to an onboard diagnostics connector (OBD-II). Via the CAN bus, OBD-II, and/or other wired or wireless mechanisms, the computer 105 may transmit messages to various devices in a vehicle and/or receive messages from the various devices, e.g., controllers, actuators, sensors, etc., including sensors 110. Alternatively or additionally, in cases where the computer 105 actually comprises multiple devices, the CAN bus or the like may be used for communications between devices represented as the computer 105 in this disclosure. In addition, the computer 105 may be programmed for communicating with the network 125, which, as described below, may include various wired and/or wireless networking technologies, e.g., cellular, Bluetooth, wired and/or wireless packet networks, etc.

Collected data 115 may include a variety of data collected in a vehicle 101. Examples of collected data 115 are provided above, and moreover, data 115 is generally collected using one or more sensors 110, and may additionally include data calculated therefrom in the computer 105, and/or at the server 130. In general, collected data 115 may include any data that may be gathered by the sensors 110 and/or computed from such data.

The vehicle 101 can include a plurality of vehicle components 120. In this context, each vehicle component 120 includes one or more hardware components adapted to perform a mechanical function or operation—such as moving the vehicle 101, slowing or stopping the vehicle 101, steering the vehicle 101, etc. Non-limiting examples of components 120 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, or the like.

When the computer 105 partially or fully operates the vehicle 101, the vehicle 101 is an “autonomous” vehicle 101. For purposes of this disclosure, the term “autonomous vehicle” is used to refer to a vehicle 101 operating in a fully autonomous mode. A fully autonomous mode is defined as one in which each of vehicle propulsion, braking, and steering are controlled by the computer 105. A semi-autonomous mode is one in which at least one of vehicle propulsion, braking, and steering are controlled at least partly by the computer 105 as opposed to a human operator. In a non-autonomous mode, i.e., a manual mode, the vehicle propulsion, braking, and steering are controlled by the human operator.

The system 100 can further include a network 125 connected to a server 130 and a data store 135. The computer 105 can further be programmed to communicate with one or more remote sites such as the server 130, via the network 125, such remote site possibly including a data store 135. The network 125 represents one or more mechanisms by which a vehicle computer 105 may communicate with a remote server 130. Accordingly, the network 125 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The network 125 can be a vehicle-to-everything network (V2X), where “X” signifies an entity with which a vehicle can communicate, e.g., a vehicle (V2V), infrastructure (V2I), a pedestrian (V2P), etc. The computer 105 can communicate with one or more devices over the V2X network, e.g., with another vehicle 101, with a device mounted to infrastructure, to a user outside of the vehicle 101, etc. One example of a V2X network 125 is a cellular-V2X (C-V2X) network. The C-V2X network is a band of frequencies dedicated to V2X communications, e.g., between vehicles 101, portable devices 140, etc. For example, the C-V2X network can include frequencies between 5.90 and 5.99 gigahertz (GHz) (e.g., 5.85-5.925 GHz).

A portable device 140 can be any one of a variety of computers that can be used while carried by a person, e.g., a smartphone, a tablet, a personal digital assistant, a smart watch, a vibrating apparatus, etc. The portable device 140 can communicate via the network 125 and also directly with a vehicle computer 105, e.g., using Bluetooth®. The portable device 140 includes a processor 145 programmed to run one or more applications stored in a memory. An “application” is programming stored in the memory that includes instructions that the processor 145 executes to perform an operation. For example, the application can be a communications application that transmits a location of the portable device 140 over the network 125 to, e.g., the computer 105, the server 130, etc.

An example of an application on a device 140 is a vehicle-to-pedestrian (V2P) application. A V2P application includes instructions to transmit data 115 from the processor 145 over the network 125 to the computer 105 and/or the server 130 and to receive data 115 from the computer 105 and/or the server 130. That is, the V2P application includes instructions for the portable device 140 (typically carried by a pedestrian) to communicate with one or more vehicles 101. Example communications by V2P applications include, e.g., transmission of a location of the portable device 140 to the vehicles 101, transmission of a collision warning from the vehicles 101 to the portable device 140, transmission of a traffic signal from the vehicles 101 to the portable device 140, etc. Because the V2P applications use bandwidth over the network 125, the processor 145 can suppress communication by the V2P applications when communication is not necessary, e.g., when the portable device 140 is in one of the vehicles 101.

The portable device 140 can include at least one sensor 150. The sensor 150 any one of a variety of sensors that can provide data to determine motion and/or a location of a device 140, e.g., an accelerometer, a gyroscope, a global position sensor, or some other sensor that can provide data to determine motion and/or location of the device 140. The sensor 150 can collect data 115 on the position of the portable device 140 relative to the vehicle 101. The processor 145 can transmit the data 115 collected by the sensor 150 over the network 125 to the computer 105 and/or the server 130.

Further, various controllers in a vehicle may operate as sensors 110, 150 to provide data 115 via the CAN bus and/or the network 125, e.g., data 115 relating to vehicle speed, acceleration, system and/or component functionality, etc., of any number of vehicles 101. Yet further, sensors or the like, global positioning system (GPS) equipment, etc., could be included in a vehicle 101 and/or the portable device 140 and configured as sensors 110, 15 to provide data directly to the computer 105, e.g., via a wired or wireless connection. Vehicle 101 sensors 110 could include mechanisms such as RADAR, LIDAR, sonar, etc. sensors that could be deployed to measure a distance between the vehicle 101 and other vehicles or objects. Yet other sensors 110, 150 could include cameras, breathalyzers, motion detectors, etc., i.e., sensors 110, 150 to provide data 115 for evaluating a condition or state of a vehicle 101 operator.

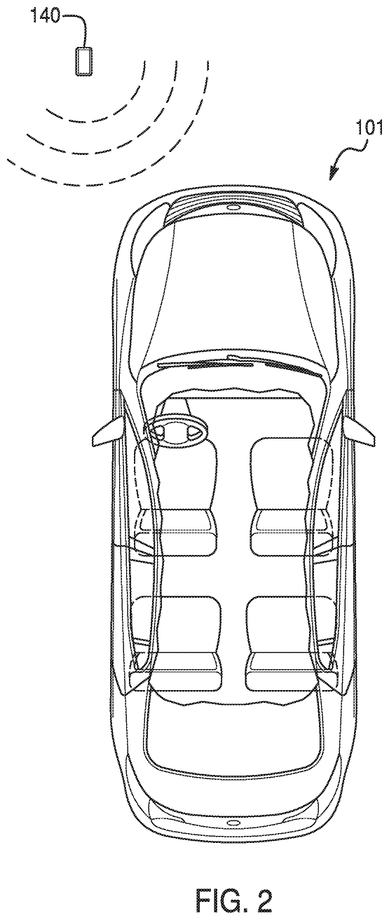

FIG. 2 shows an example vehicle 101 and an example portable device 140. The portable device 140 communicates with the vehicle 101 over the network 125, e.g., a C-V2X network as described above. The portable device 140 includes an application that transmits a location of the portable device 140 to the computer 105. For example, the application can be a V2P application, as described above, that allows the computer 105 to warn the user in possession of the portable device 140 that the vehicle 101 is approaching. Upon transmitting the location of the portable device 140 to the computer 105, the computer 105 can determine whether the vehicle 101 is at risk of colliding with the user in possession of the portable device 140. The computer 105 can then send a warning to the processor 145. For example, the computer 105 can send a warning indicating that the vehicle 101 is approaching and that the user in possession of the portable device 140 should stop and/or avoid the vehicle 101. Additionally or alternatively, the computer 105 can send, e.g., a collision warning, a traffic signal, etc., over the network 125 to the portable device 140.

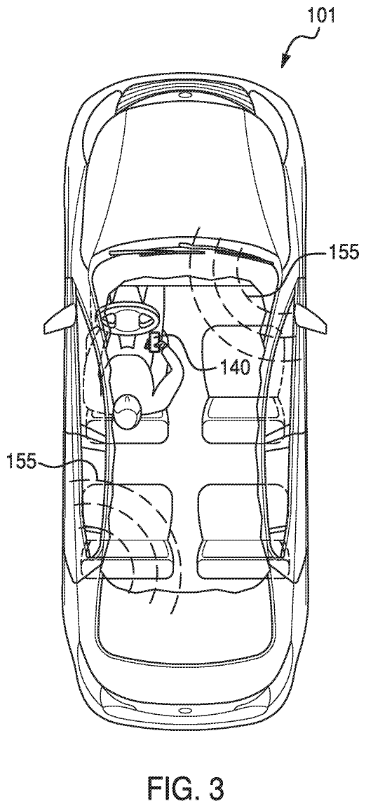

FIG. 3 shows the portable device 140 inside the vehicle 101. The portable device 140 is “in” or “inside” the vehicle 101 when the portable device 140 is disposed within a passenger cabin of the vehicle 101. When the portable device 140 is in the vehicle 101, the processor 145 suppresses communication of one or more V2P applications to reduce bandwidth use by the portable device 140. That is, the V2P applications typically transmit a location of the portable device 140 to vehicle 101 to protect users from oncoming vehicles 101. Because the portable device 140 is in the vehicle 101, the user in possession of the portable device 140 is not in danger of a vehicle-to-pedestrian collision and suppressing communication of V2P applications frees available bandwidth for other portable devices 140 outside of the vehicle 101.

The processor 145 can determine that the portable device 140 is in the vehicle 101 based on geo-location data 115. The processor 145 can request, e.g., from the server 130, a geo-location of the portable device 140 and a geo-location of the vehicle 101. A “geo-location” is a set of coordinates (e.g., latitude and longitude) indicating a location on the surface of the earth, e.g., with respect to a global coordinate system. The processor 145 can determine a distance between the geo-location of the portable device 140 and the geo-location of the vehicle 101, e.g., with the Pythagorean Theorem applied to a right triangle having legs that are the difference in the latitude and the difference in longitude, respectively, of the geo-locations of the portable device 140 and the vehicle 101. If the distance is within a distance threshold (i.e., the portable device 140 is within the distance threshold of the vehicle 101), the processor 145 can determine that the portable device 140 is in the vehicle 101. The distance threshold can be a smallest distance between two points on an exterior of the vehicle 101, e.g., a width of the vehicle 101. The distance threshold can be, e.g., 1.75 meters. That is, if the geo-location of the portable device 140 is within 1.75 meters of the geo-location of the vehicle 101, the processor 145 can determine that the portable device 140 is in the vehicle 101.

The processor 145 can determine that the portable device 140 is in the vehicle 101, i.e., in the passenger cabin and/or a luggage compartment inside the vehicle 101 body, i.e., in a vehicle 101 interior, when data 115 from one or more portable device sensors 150 indicate that the portable device 140 is moving at a speed and/or acceleration substantially at the speed and/or acceleration of the vehicle 101. When the portable device 140 is in the vehicle 101, the portable device 140 can have a speed and/or acceleration substantially at, i.e., the same as, the speed and/or acceleration of the vehicle 101. The speed and/or acceleration are typically greater, often by an order of magnitude, than a speed and/or acceleration of a user in possession of the portable device 140 outside of the vehicle 101. For example, the processor 145 can identify a geo-location of the portable device 140 at specified intervals of time (i.e., periodically), and can predict a speed of the portable device 140 based on the geo-location data 115. That is, the processor 145 can determine the average distance between geo-location data 115 over a time elapsed collecting the geo-location data 115 to predict the speed of the portable device 140. If the predicted speed is above a speed threshold determined as a speed faster than average user speeds, the processor 145 can determine that the portable device 140 is inside the vehicle 101. The speed threshold can be, e.g., 20 kilometers per hour (kph), 25 kph, 30 kph, etc. That is, users typically walk more slowly than 20 kph, and vehicles 101 typically move faster than 20 kph, and when the processor 145 determines that the portable device 140 has a speed exceeding 20 kph, the portable device 140 is likely in the vehicle 101. Additionally, movement of the portable device 140 in the vehicle 101 can result in an angular velocity of the portable device 140 typically greater than an angular velocity of the portable device 140 outside of the vehicle 101.

The portable device sensors 150 can collect data 115 of a speed, acceleration, and/or angular velocity of the portable device 140. For example, the sensors 150 can include an accelerometer that collects acceleration data. In another example, the sensors 150 can include a gyroscope that collects angular velocity data. In yet another example, the sensors 150 can include a speed sensor that collects position and time data of the portable device 140 to determine the speed of the portable device 140. The processor 145 can compare the speed, acceleration, and angular velocity to respective speed, acceleration, and angular velocity thresholds. The speed threshold can be a fixed value above an average speed of a pedestrian, as described above at 20 kph, a maximum speed of a user on a bicycle (i.e., a typical maximum speed of a user in possession of the portable device 140 outside of the vehicle), e.g., 40 kilometers per hour. The acceleration threshold can be a maximum braking acceleration of a bicycle, e.g., 9 meters per second squared. The angular velocity threshold can be a maximum angular velocity of a bicycle, e.g., 0.1 radians per second.

The computer 105 can send a message to the processor 145 indicating that the portable device 140 is in the vehicle 101. The computer 105 can send a message over the network 125, e.g., via one or more of DSRC, Bluetooth®, Wi-Fi, C-V2X, etc., when the computer 105 detects the portable device 140 in the vehicle 101. Alternatively or additionally, the computer 105 can provide a periodic message 155 to the processor 145 indicating that the portable device 140 is in the vehicle 101. For example, the computer 105 can actuate one or more cabin lights in a passenger cabin of the vehicle 101 in a sequence of light pulses at a specified pattern. The specified pattern can be, e.g., 1 pulse every 500 milliseconds. The processor 145 can actuate one or more sensors 150 to receive the light pulses of the periodic message 155. The processor 145 can include instructions that indicate that the specified pattern is a message from the computer 105 indicating that the portable device 140 is in the vehicle 101. Upon identifying the specified pattern, the processor 145 can determine that the portable device 140 is in the vehicle 101. Alternatively or additionally, the computer 105 can send the periodic message 155 over the network 125, e.g., via Bluetooth® Low Energy, DSRC, Wi-Fi, C-V2X, etc.

Upon determining that the portable device 140 is in the vehicle 101, the processor 145 identifies V2P applications. As one example, the processor 145 can identify the V2P applications based on messages that the applications are programmed to instruct the processor 145 to send. For example, if the application includes instructions to transmit a location of the portable device 140 to the computer 105 and/or the server 130, the processor 145 can identify the application as a V2P application. In another example, if the application includes instructions to receive a collision warning and/or a traffic signal from the computer 105 and/or the server 130, the processor 145 can identify the application as a V2P application. In yet another example, the processor 145 can determine a message rate of an application, i.e., a time rate at which the application instructs the processor 145 to transmit a message to the computer 105 and/or the server 130. V2P applications typically have lower message rates (e.g., 1 message per second) than other applications, e.g., text messaging applications, navigation applications, etc., which can communicate with the server 130 at message rates of, e.g., 10 messages per second. If the processor 145 determines that the application has a message rate below a predetermined threshold, the processor 145 can identify the application as a V2P application. The predetermined threshold can be an average message rate for a plurality of applications determined to be V2P applications, e.g., 2 messages per second. In yet another example, the application can include a marker, e.g., a text string, a line of code, etc., that identifies the application as a V2P application and instructs the processor 145 to suppress communications of the application upon determining that the portable device 140 is in the vehicle. Such a marker can be registered with an operating system of the processor 145 that identifies the application to the processor 145 as a V2P application for suppression of communication.

Upon identifying the V2P applications, the processor 145 suppresses communication by the V2P applications. To suppress communication, the processor 145 can, upon receiving an instruction from the application to transmit a message over the network 125, execute instructions to ignore the instruction and determine not to transmit the message. Alternatively or additionally, the processor 145 can execute instructions to prevent activation of the V2P applications entirely. Suppressing the communication by the V2P applications frees bandwidth on the C-V2X network for portable devices 140 outside of the vehicle 101.

Upon a device 140 exiting the vehicle 101, the processor 145 can restore communication to the V2P application. The processor 145 can determine that the portable device 140 has exited the vehicle 101 with one or more of the techniques described above to determine that the portable device 140 is in the vehicle 101. For example, the processor 145 can determine that the portable device 140 has exited the vehicle 101 based on geo-location data of the portable device 140 and the vehicle 101. In another example, the processor 145 can determine that the portable device 140 has exited the vehicle 101 when a detected speed of the portable device 140, determined from data 115 from one or more sensors 150, is below a speed threshold. Upon determining that the portable device 140 is outside the vehicle 101, the processor 145 restores communication to the V2P application and transmits the location of the portable device 140 to nearby vehicles 101 over the network 125.

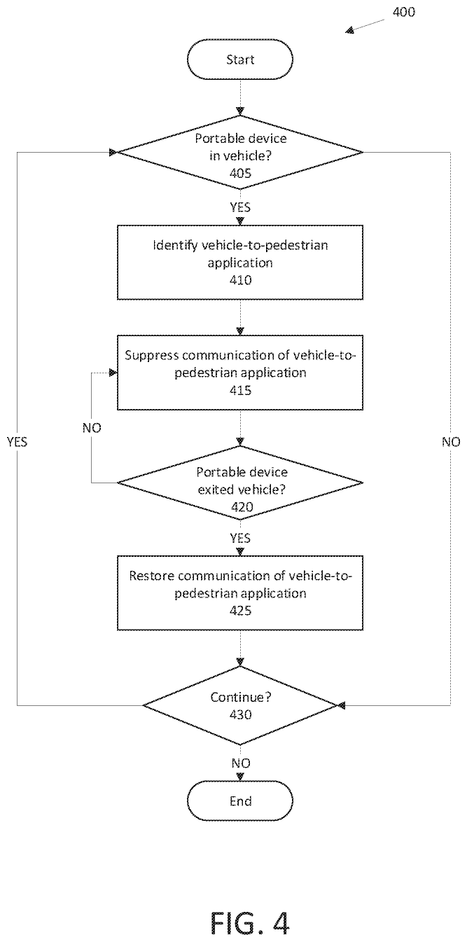

FIG. 4 is a block diagram of an example process 400 for operating a portable device 140. The process 400 begins in a block 405, in which a processor 145 in the portable device 140 determines whether the portable device 140 is in a vehicle 101. As described above, the processor 145 can determine that the portable device 140 is in the vehicle 101 based on, e.g., geo-location data 115 of the portable device 140 and the vehicle 101, a communication over the network 125 from a computer 105 in the vehicle 101, speed data 115 of the portable device 140, etc. If the processor 145 determines that the portable device 140 is in a vehicle 101, the process 400 continues in a block 410. Otherwise, the process 400 continues in a block 430.

In the block 410, the processor 145 identifies a V2P application on the portable device 140. As described above, the V2P application is an application that includes programming to transmit a location of the portable device 140 to one or more vehicles 101. The V2P application transmits the location over the network 125, consuming bandwidth over the C-V2X network 125. Alternatively, the processor 145 can identify the V2P application based on a message rate of the application.

Next, in a block 415, the processor 145 suppresses communication of the V2P application. As described above, the processor 145 prevents communication by the V2P application over the network 125, e.g., the C-V2X network. Because the portable device 140 does not need to communicate with vehicles 101 when inside the vehicle 101, suppressing communication of the V2P application frees available bandwidth on the C-V2X network 125 for portable devices 140 outside of the vehicle 101.

Next, in a block 420, the processor 145 determines whether the portable device 140 has exited the vehicle 101. As described above, the processor 145 can determine that the portable device 140 has exited the vehicle 101 based on, e.g., geo-location data 115 of the portable device 140 and the vehicle 101, communications between the computer 105 and the processor 145, etc. If the processor 145 determines that the portable device 140 has exited the vehicle 101, the process 400 continues in a block 425. Otherwise, the process 400 returns to the block 415.

In the block 425, the processor 145 restores communication by the V2P application. Because the portable device 140 is outside the vehicle 101, the processor 145 can implement V2P applications to communicate with vehicles 101 over the C-V2X network. Thus, the processor 145 can transmit the location of the portable device 140 to vehicles 101, and computer 105 in the vehicle 101 can transmit warnings to the processor 145.

Next, in a block 430, the processor 145 determines whether to continue the process 400. For example, the processor 145 can determine not to continue the process 400 when the processor 145 receives user input to power down the portable device. If the processor 145 determines to continue, the process 400 returns to the block 405. Otherwise, the process 400 ends.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, data collector measurements, computations, processing time, communications time, etc.

Computing devices discussed herein, including the computer 105, the server 130, and the portable device 140 include processors and memories, the memories generally each including instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computer 105 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 400, one or more of the steps could be omitted, or the steps could be executed in a different order than shown in FIG. 4. In other words, the descriptions of systems and/or processes herein are provided for the purpose of illustrating certain embodiments and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

1. A portable device including a processor and a memory, the memory storing instructions executable by the processor to:
identify the portable device as being in a vehicle;
identify a vehicle-to-pedestrian application on the portable device that is configured to transmit a location of the portable device to the vehicle to a computer of the vehicle regardless of the location of the portable device relative to the vehicle; and
suppress communication by the identified vehicle-to-pedestrian application.

2. The portable device of claim 1, wherein the instructions further include instructions to identify the vehicle-to-pedestrian application upon determining that the vehicle-to-pedestrian application instructs the portable device to communicate with the vehicle over a cellular network.

3. The portable device of claim 2, wherein the cellular network is a Cellular Vehicle-to-Everything (C-V2X) network.

4. The portable device of claim 1, wherein the instructions further include instructions to identify a geo-location of the portable device and to identify the portable device as being in the vehicle upon determining that the geo-location of the portable device is within a distance threshold of a geo-location of the vehicle.

5. The portable device of claim 1, wherein the instructions further include instructions to identify the portable device as being in the vehicle based on data indicating at least one of speed, acceleration, or angular velocity of the portable device.

6. The portable device of claim 5, wherein the instructions further include instructions to actuate one or more portable device sensors to collect the data.

7. The portable device of claim 1, wherein the instructions further include instructions to, upon receiving a periodic message from the vehicle, identify the portable device as being in the vehicle.

8. The portable device of claim 7, wherein the periodic message is a sequence of light pulses emitted from a vehicle cabin light.

9. The portable device of claim 1, wherein the instructions to identify the vehicle-to-pedestrian application further include instructions to determine that the vehicle-to-pedestrian application includes programming to receive at least one of a collision warning or a traffic signal from the vehicle.

10. The portable device of claim 1, wherein the instructions further include instructions to, upon determining that the portable device has exited the vehicle, allow communication by the vehicle-to-pedestrian application.

11. The portable device of claim 1, wherein the instructions to identify the vehicle-to-pedestrian application further include instructions to determine a message rate of an application and to identify the vehicle-to-pedestrian application when the message rate is below a predetermined threshold.

12. The portable device of claim 1, wherein the instructions to identify the application further include instructions to determine that the vehicle-to-pedestrian application is programmed to transmit a heading of the portable device to the vehicle.

13. A method, comprising:
identifying a portable device as being in a vehicle;
identifying a vehicle-to-pedestrian application on the portable device that is configured to transmit a location of the portable device to a computer of the vehicle regardless of the location of the portable device relative to the vehicle; and
suppressing communication by the application.

14. The method of claim 13, further comprising identifying the vehicle-to-pedestrian application upon determining that an application instructs the portable device to communicate with the vehicle over a cellular network.

15. The method of claim 13, further comprising identifying the vehicle-to-pedestrian application that is configured to to receive at least one of a collision warning or a traffic signal from the vehicle.

16. The method of claim 13, further comprising, upon determining that the portable device has exited the vehicle, allowing communication by the vehicle-to-pedestrian application.

17. A system, comprising:
a portable device including a vehicle-to-pedestrian application that is configured to transmit a location of the portable device to a computer of a vehicle regardless of the location of the portable device relative to the vehicle;
means for identifying the portable device as being in the vehicle;
means for identifying the vehicle-to-pedestrian application; and
means for suppressing communication by the vehicle-to-pedestrian application.

18. The system of claim 17, further comprising means for identifying the vehicle-to-pedestrian application upon determining that the vehicle-to-pedestrian application instructs the portable device to communicate with the vehicle over a cellular network.

19. The system of claim 17, further comprising means for identifying the vehicle-to-pedestrian application that is configured to to receive at least one of a collision warning or a traffic signal from the vehicle.

20. The system of claim 17, further comprising means for allowing communication by the vehicle-to-pedestrian application upon determining that the portable device has exited the vehicle.
